(19) United States
(12) Patent Application Publication
(10) Pub. No.: US 2010/0318766 A1
(43) Pub. Date: Dec. 16, 2010

(54) PROCESSOR AND INFORMATION PROCESSING SYSTEM

(75) Inventor: Masayuki TSUJI, Yokohama (JP)

Correspondence Address: Fujitsu Patent Center;Fujitsu Management Services of America, Inc., 2318 Mill Road, Suite 1010, Alexandria, VA, 22314, US

(73) Assignee: FUJITSU SEMICONDUCTOR LIMITED, Yokohama-shi (JP)

(21) Appl. No.: 12/795,478

(22) Filed: Jun. 7, 2010

(30) Foreign Application Priority Data
Jun. 16, 2009 (JP) 2009-143648

(51) Int. Cl. G06F 15/76; G06F 9/02

(52) U.S. Cl. 712/22; 712/E09.002

(57) ABSTRACT

A processor includes a processing unit capable of executing single-instruction multiple-data operations; a register file configured to store data that is to be supplied to the processing unit and to be subjected to operations, and a buffer provided separately from the register file, the buffer being a buffer where an integer “n” number of data columns each having a plurality of data elements are written on a column-by-column basis, and data elements at the same location are selected and read as “n” data elements from the respective “n” data columns, wherein the “n” data elements read from the buffer is supplied to the processing unit as data to be subjected to a single-instruction multiple-data operation.

### CROSS REFERENCE TO RELATED APPLICATION

This application is based upon and claims the benefit of priority from the prior Japanese Patent Application NO. 2009-143648 filed on Jun. 16, 2009, the entire contents of which are incorporated herein by reference.

### FIELD

The embodiments discussed herein are related to processors capable of executing single-instruction multiple-data (SIMD) operations and information processing systems including the processors.

### BACKGROUND

Typical reduced-instruction-set computer (RISC) processors and digital signal processors (DSPs) execute a single instruction to perform a single operation on a single piece of data. On the other hand, processors having SIMD instructions are capable of performing the same operation on multiple pieces of data in parallel by executing a single instruction. When a SIMD instruction is executed, data stored in one entry of a register file is treated as multiple pieces of data arranged in some form, each piece of data having a size smaller than the data size of one entry. Thus, an operation is performed on these multiple pieces of data in parallel. For example, first, one long-size (4-byte) data is transferred from an external memory to one entry of a register file included in a processor. Next, in response to a SIMD instruction, the long-size data stored in the entry of the register file is treated as four pieces of 1-byte data, on which an operation is executed in parallel. Then, the four pieces of 1-byte data processed in parallel in response to the SIMD instruction are stored again as one long-size data in one entry of the register file. Last, a result of this operation is transferred as one long-size data and written back to the external memory.

SIMD operations are effective for discrete cosine transform (DCT) and filter operations. However, as described below, known RISC processors and DSPs having a SIMD operation function request data rearrangement as pre-processing for a SIMD operation. For example, assume that a plurality of horizontal lines of a screen is to be filtered in the horizontal direction. In this case, a plurality of pixels to be processed in parallel in a SIMD operation are pixels arranged in the vertical direction of the screen. However, a plurality of pixels that may be transferred at once from an external memory to one entry of a register file are a series of data stored in memory space, that is, a plurality of pixels arranged in the horizontal direction. For example, for transfer of long-size data, data to be transferred at once from the external memory to one entry of the register file is four pieces of 1-byte pixel data arranged in the horizontal direction of an image. A plurality of pixels to be processed in parallel in the SIMD operation are pixels arranged in the vertical direction of the screen. Therefore, as a preparation for the SIMD operation, it is requested that the pixels arranged in the vertical direction be rearranged in the horizontal direction. This is a copy operation which involves rotating the image by 90 degrees. Therefore, in addition to many memory accesses, the copy operation requests many shift operations and logical operations in the register file. Since this involves use of many processing cycles, very large overhead will result.

As a means to solve such an overhead problem, a configuration of a processor is known in which a set of data streams stored in a plurality of entries in a register file and to be subjected to a SIMD operation may be read or written at once (see Japanese Laid-Open Patent Publication No. 2005-309499). This processor includes a plurality of memory banks obtained by dividing a register file. With this configuration, multiple pieces of data in different entries in the register file may be transferred to and from a SIMD processing unit without combining these pieces of data into one entry. Since it is thus possible to eliminate overhead that is associated with data rearrangement performed as pre-processing for a SIMD operation, a significant improvement in performance may be expected.

However, the above-described technique requests a plurality of memory banks, an address generating circuit for writing and reading data to and from the plurality of memory banks, and a control circuit for each of the plurality of memory banks. This makes circuitry larger than that for a configuration having a typical register file, and causes a longer delay in writing and reading data to and from the register file.

Japanese Laid-Open Patent Publication No. 2005-309499 and Japanese Laid-Open Patent Publication No. 10-74141 are examples of related art.

### SUMMARY

According to an aspect of the embodiments, a processor includes a processing unit capable of executing single-instruction multiple-data operations; a register file configured to store data that is to be supplied to the processing unit and to be subjected to operations; and a buffer provided separately from the register file, the buffer being a buffer where an integer “n” number of data columns each having a plurality of data elements are written on a column-by-column basis, and data elements at the same location are selected and read as “n” data elements from the respective “n” data columns. The “n” data elements read from the buffer is supplied to the processing unit as data to be subjected to a single-instruction multiple-data operation.

The object and advantages of the embodiments will be realized and attained by means of the elements and combinations particularly pointed out in the claims.

It is to be understood that both the foregoing general description and the following detailed description and are exemplary and explanatory and are not restrictive of the embodiments, as claimed.

### BRIEF DESCRIPTION OF DRAWINGS

FIG. 1 illustrates a configuration of an information processing system;

FIG. 2 is a flowchart illustrating a flow of data rearrangement and SIMD operations performed by a processor illustrated in FIG. 1;

FIG. 3A to FIG. 3J illustrate data contents in a buffer during data rearrangement and SIMD operations;

FIG. 4A and FIG. 4B illustrate pipeline operations in the data rearrangement and SIMD operations illustrated in FIG. 2;

FIG. 5A to FIG. 5F are diagrams for explaining a series of operations of a buffer enable register;

FIG. 6 illustrates a configuration of a modified processor;

FIG. 7A and FIG. 7B illustrate configurations of a first buffer and a second buffer, respectively; and

FIG. 8 illustrates a configuration of an information processing system including a media processor.

### DESCRIPTION OF EMBODIMENTS

Embodiments are described in detail with reference to the attached drawings.

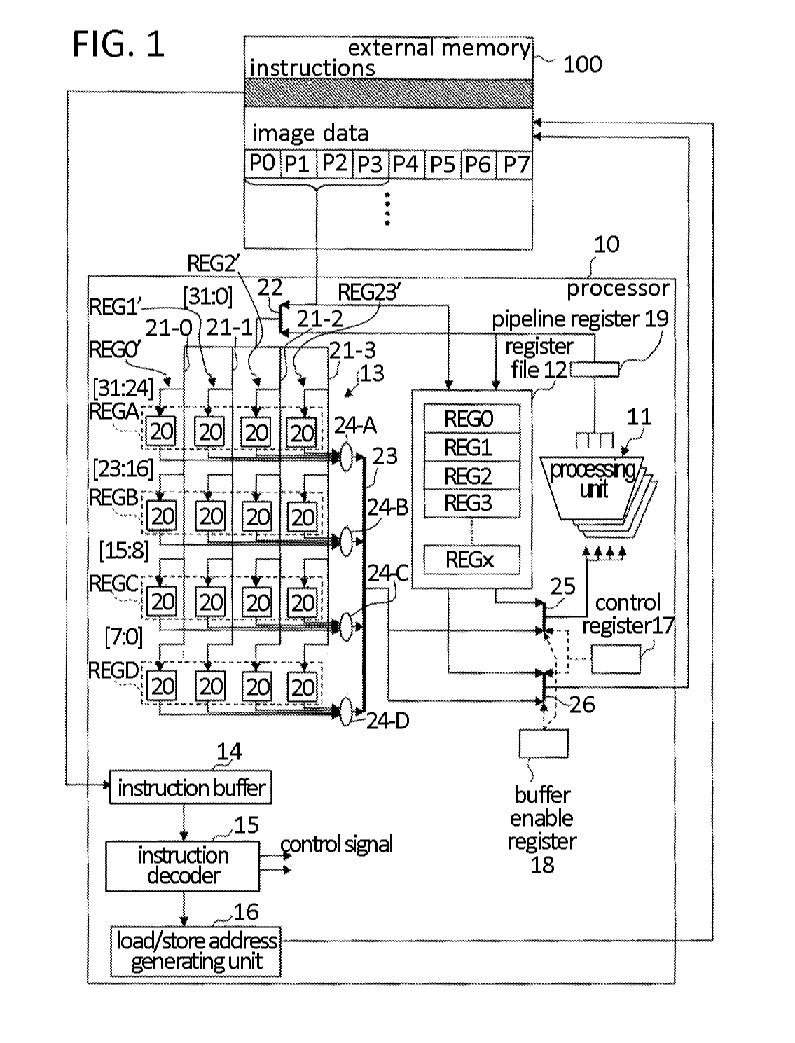

FIG. 1 illustrates a configuration of an information processing system. The information processing system illustrated in FIG. 1 includes a processor 10 and an external memory 100. The processor 10 is coupled to the external memory 100 and reads instructions and data from the external memory 100. The external memory 100 stores image data including pieces of pixel data P0, P1, P2, etc. Although the following description assumes that each of the pieces of pixel data P0, P1, P2, etc. is 8-bit data, the number of bits for each pixel is not limited to this. Also, data stored in the external memory 100 and to be processed by the processor 10 is not limited to image data.

The processor 10 includes a processing unit 11, a register file 12, a buffer 13, an instruction buffer 14, an instruction decoder 15, a load/store-address generating unit 16, a control register 17, a buffer enable register 18, and a pipeline register 19. The processor 10 further includes a selector 25 and a selector 26.

The processor 10 reads, from the external memory 100, an instruction stored at an address indicated by a program counter (not shown), and stores the read instruction in the instruction buffer 14. The instruction fetched from the instruction buffer 14 is decoded by the instruction decoder 15. The instruction decoder 15 includes a sequencer that controls an operation sequence of the processor 10. The instruction decoder 15 generates an appropriate control signal depending on the decoded instruction. An operation sequence of each unit of the processor 10 is controlled by such a control signal. If the decoded instruction is, for example, a load instruction or a store instruction, the load/store-address generating unit 16 generates an address for loading or storing. If the decoded instruction is a load instruction, the processor 10 reads, from the external memory 100, data stored at the address for loading. If the decoded instruction is a store instruction, the processor 10 stores, in the external memory 100, data at the address for storing.

On the basis of the control signal from the instruction decoder 15, the processing unit 11 executes an operation corresponding to the instruction decoded by the instruction decoder 15. The processing unit 11 is capable of executing SIMD operations, and may also be capable of executing single-instruction single-data (SISD) operation instructions. In a SIMD operation, the processing unit 11 executes the same operation in parallel on multiple data elements supplied from the register file 12 or the buffer 13.

The register file 12 has registers REG0 to REGx as its entries. The register file 12 stores data to be supplied to the processing unit 11 for operations, and also stores data obtained by operations executed by the processing unit 11. Each of the registers REG0 to REGx stores, for example, 32-bit wide data. When 32-bit (4-byte) wide data stored in one entry is subjected to a SIMD operation, the same operation is executed, for example, on four 1-byte data elements in parallel. The following description refers to an example in which 32-bit wide data is stored in one register, and multiple data elements to be processed in parallel in a SIMD operation are four pieces of 1-byte data. Note, however, that the bit width of each of the registers REG0 to REGx, the size of each data element, and the number of multiple data elements are not limited to those in this example.

The buffer 13 includes a plurality of register elements 20, a selector 22, and a selector 23. Each of the plurality of register elements 20 may include, for example, eight flip-flops for storing an 8-bit data element. Four register elements 20 whose inputs are connected to a signal line 21-0 constitute one register REG0′. Four register elements 20 whose inputs are connected to a signal line 21-1 constitute one register REG1′. Four register elements 20 whose inputs are connected to a signal line 21-2 constitute one register REG2′. Four register elements 20 whose inputs are connected to a signal line 21-3 constitute one register REG3′.

Long-size (4-byte) image data (e.g., P0, P1, P2, and P3) read as a data block from the external memory 100 in response to a load instruction is stored in one register designated from among the registers REG0′ to REG3′. This load instruction may be an instruction to load data into a designated register in the register file 12. For example, when a load instruction to load data into the register REG0 in the register file 12 is executed, 4-byte image data read from the external memory 100 is stored in the register REG0 and also stored via the selector 22 in the register REG0′ in the buffer 13. The registers REG0 to REG3 in the register file 12 correspond to the registers REG0′ to REG3′ in the buffer 13, respectively. That is, data stored in one register REGk (k=0, 1, 2, or 3) in the register file 12 is also stored in the corresponding register REGk′ in the buffer 13. A determination as to which register is to be used to store data in response to a load instruction is controlled by a control signal from the instruction decoder 15.

Four register elements 20 whose outputs are connected to a signal-line coupling unit 24-A constitute one register REGA. Four register elements 20 whose outputs are connected to a signal-line coupling unit 24-B constitute one register REGB. Four register elements 20 whose outputs are connected to a signal-line coupling unit 24-C constitute one register REGC. Four register elements 20 whose outputs are connected to a signal-line coupling unit 24-D constitute one register REGD. Each of the signal-line coupling units 24-A to 24-D arranges and combines 8-bit outputs from the respective register elements 20 to form 32-bit data, which is supplied to the selector 23. The selector 23 selects and outputs one of the outputs of the registers REGA to REGD. A determination as to which register's data is to be selected is controlled by a control signal from the instruction decoder 15.

Thus, the buffer 13 serves as a buffer where an integer number “n” of data columns each having a plurality of data elements may be written on a column-by-column basis, and data elements at the same location may be selected and read as “n” data elements from the respective “n” data columns. In the example configuration of FIG. 1, four data columns, each having four pieces of pixel data, are written on a column-by-column basis. Specifically, first, a data column having four pieces of pixel data P0 to P3 is stored in the register REG0′. Next, a data column having four pieces of pixel data P4 to P7 is stored in the register REG1′. Next, a data column having four pieces of pixel data P8 to P11 is stored in the register REG2′. Then, a data column having four pieces of pixel data P12 to P15 is stored in the register REG3′. Thus, four data columns are stored in the respective four registers REG0′ to REG3′.

For reading of data, pieces of pixel data at the same location are selected from respective four data columns and read as four pieces of pixel data. For example, assume that the third pixel data in each data column (i.e., the 15th to 8th bits [15:8] in each long-size 32-bit data) is selected. In this case, four sets of the 15th to 8th bits [15:8] of the respective four data columns are combined by the signal-line coupling unit 24-C to form 4-byte data, which is selected by the selector 23 and output. Thus, four pieces of pixel data P2, P6, P10, and P14 are output from the selector 23. Similarly, for example, assume that the first pixel data in each data column (i.e., the 31st to 24th bits [31:24] in each long-size 32-bit data) is selected. In this case, four sets of the 31st to 24th bits [31:24] of the respective four data columns are combined by the signal-line coupling unit 24-A to form 4-byte data, which is selected by the selector 23 and output. Thus, four pieces of pixel data P0, P4, P8, and P12 are output from the selector 23.

When the processing unit 11 performs a SIMD operation, data to be subjected to the SIMD operation is supplied from the register file 12 or the buffer 13. The selector 25 selects data in the register file 12 or data in the buffer 13 and supplies the selected data to the processing unit 11. The selecting operation of the selector 25 may be controlled by a control signal from the instruction decoder 15, the control signal corresponding to an operation instruction to be executed. For example, in response to a first operation instruction, the selector 25 supplies data read from the register file 12 to the processing unit 11, as a target of the SIMD operation instruction. Also, in response to a second operation instruction different from the first operation instruction, the selector 25 supplies data read from the buffer 13 to the processing unit 11, as a target of the SIMD operation instruction. In this way, a SIMD operation instruction for data in the register file 12 and a SIMD operation instruction for data in the buffer 13 may be provided separately such that data in one of the register file 12 and the buffer 13 is selected depending on the operation instruction to be executed.

When the processor 10 executes a data store instruction, data to be stored in the external memory 100 is supplied from the register file 12 or the buffer 13. The selector 26 selects data in the register file 12 or data in the buffer 13 and supplies the selected data to the external memory 100. The selecting operation of the selector 26 may be controlled by a control signal from the instruction decoder 15, the control signal corresponding to a store instruction to be executed. For example, in response to a first store instruction, the selector 26 outputs data read from the register file 12 to the outside of the processor 10, as a target of the store instruction. Also, in response to a second store instruction different from the first store instruction, the selector 26 outputs data read from the buffer 13 to the outside of the processor 10, as a target of the store instruction. In this way, a store instruction for data in the register file 12 and a store instruction for data in the buffer 13 may be provided separately such that data in one of the register file 12 and the buffer 13 is selected depending on the store instruction to be executed.

The control register 17 may control the selecting operation of the selectors 25 and 26. When a register setting instruction included in a program to be executed is decoded by the instruction decoder 15, a storage value corresponding to the decoded instruction is set in the control register 17. Depending on the storage value in the control register 17, the selectors 25 and 26 select data read from the register file 12 or data read from the buffer 13 and output the selected data. Thus, the selection of data from one of the register file 12 and the buffer 13 may be controlled by software.

The buffer enable register 18 may control the selecting operation of the selectors 25 and 26. The buffer enable register 18 stores a value indicating whether data stored in the buffer 13 is valid. Depending on the value stored in the buffer enable register 18, the selectors 25 and 26 select data read from one of the register file 12 and the buffer 13 and output the selected data.

Any one or more than one of the above-described selection control operations (i.e., selection control performed by the instruction decoder 15 in response to an instruction, selection control performed by the control register 17, and selection control performed by the buffer enable register 18) may be provided. When more than one of these selection control operations is provided at the same time, priorities may be assigned to the respective selecting operations. For example, even if an output from the buffer 13 is selected by the selection control performed by the buffer enable register 18, there may be a case where an output from the register file 12 is explicitly selected by an instruction being executed. In such a case, for example, a higher priority may be given to the selection control performed by the instruction decoder 15 in accordance with the instruction so that the output from the register file 12 is selected.

Thus, when the buffer 13 where data may be stored sequentially on a column-by-column basis and may be read sequentially on a row-by-row basis is provided separately from the register file 12, data rearrangement serving as a preparation for a SIMD operation may be realized with small circuitry. Here, the number of entries in the register file 12 used when pieces of data discontinuously arranged in memory space (e.g., P0, P4, P8, and P12) are to be subjected to a SIMD operation is the same as the degree of parallelism of the SIMD operation. Therefore, buffers (four buffers, i.e., the registers REG0′ to REG3′ in the example of FIG. 1) to be used for the parallel operations are provided. Then, pieces of data to be subjected to the SIMD operation (e.g., P0, P4, P8, and P12) are stored in the respective buffers, rearranged as described above, and read. With flip-flops arranged in rows and columns to form the buffer 13, vertical and horizontal data rearrangement serving as pre-processing for the SIMD operation may be performed with a simple circuitry configuration. Since the register file 12 has a typical configuration composed of a single memory bank, the circuitry may be smaller than that for a configuration composed of a plurality of memory banks. As for the speed of writing and reading of data to and from the register file 12, there is only a slight delay associated with the operation performed by the selectors 25 and 26 to select an output from one of the register file 12 and the buffer 13. As for the number of registers (buffers) in the buffer 13 provided separately from the register file 12, the number of registers is at least the same as the degree of parallelism of the SIMD operation and thus, a very large circuitry size is not requested.

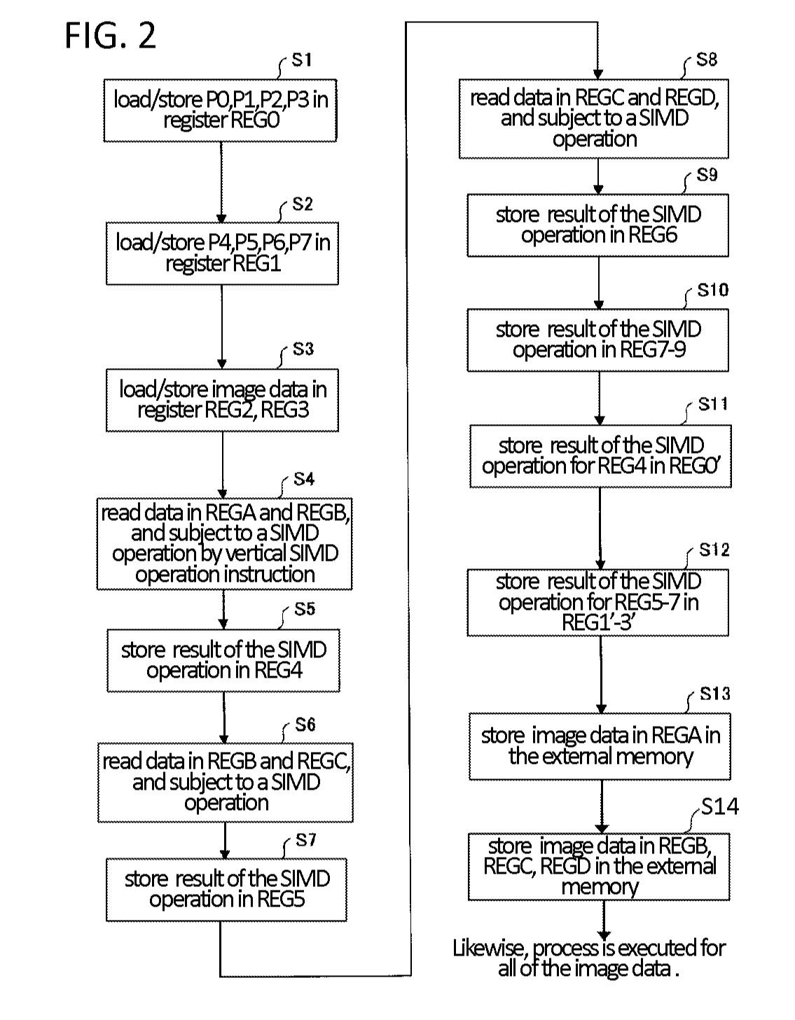

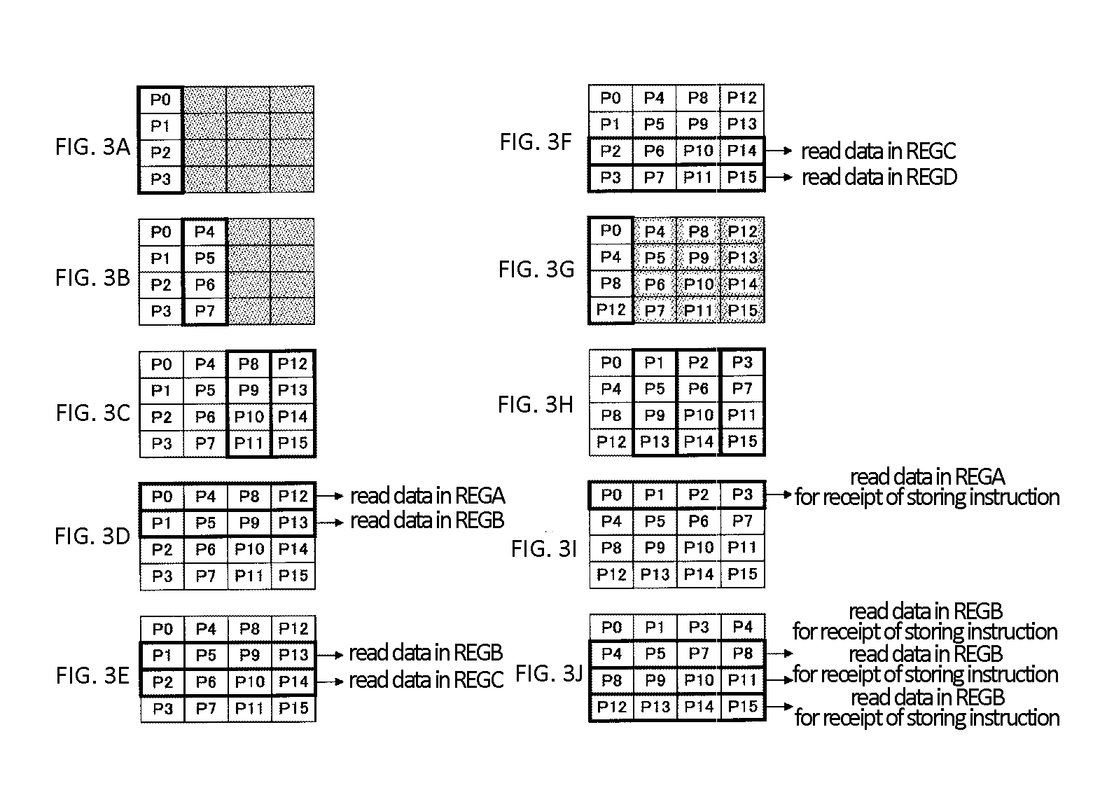

FIG. 2 is a flowchart illustrating a flow of data rearrangement and SIMD operations performed by the processor 10 illustrated in FIG. 1. FIG. 3A to FIG. 3J illustrate data contents in the buffer 13 during data rearrangement and SIMD operations. Data rearrangement and SIMD operations will now be described with reference to FIG. 2 and FIG. 3A to FIG. 31

In step S1, in response to a load instruction, pieces of image data P0, P1, P2, and P3 read from the external memory 100 are stored in the register REG0 in the register file 12. The same data is also stored in the register REG0′ in the buffer 13. FIG. 3A illustrates the buffer 13 in which the pieces of image data P0, P1, P2, and P3 are stored in the register REG0′.

In step S2, in response to a load instruction, pieces of image data P4, P5, P6, and P7 read from the external memory 100 are stored in the register REG1 in the register file 12. The same data is also stored in the register REG1′ in the buffer 13. FIG. 3B illustrates the buffer 13 in which the pieces of image data P4, P5, P6, and P7 are stored in the register REG1′.

In step S3, as in the cases of steps S1 and S2, pieces of image data P8, P9, P10, and P11 are stored in the register REG2 and pieces of image data P12, P13, P14, and P15 are stored in the register REG3. Again, the same data is stored in the register REG2′ and the register REG3′ in the buffer 13. FIG. 3C illustrates the buffer 13 in which the pieces of image data P8 to P11 are stored in the register REG2′ and the pieces of image data P12 to P15 are stored in the register REG3′.

In step S4, in response to a vertical SIMD operation instruction, data in the registers REGA and REGB is read and subjected to a SIMD operation. Here, the term “vertical SIMD operation instruction” is used to indicate that multiple pieces of data to be processed in parallel in the SIMD operation are a plurality of pixels arranged in the vertical direction of the image. Referring to FIG. 3D, for example, the pieces of pixel data P0 to P3 correspond to part of a first horizontal line of the image, and the pieces of pixel data P4 to P7 correspond to part of a second horizontal line of the image. Likewise, the pieces of pixel data P8 to P11 correspond to part of a third horizontal line of the image, and the pieces of pixel data P12 to P15 correspond to part of a fourth horizontal line of the image. In this case, multiple pieces of data to be processed in parallel in the vertical SIMD operation are, for example, the pixel data P0 at the beginning of the first horizontal line, the pixel data P4 at the beginning of the second horizontal line, the pixel data P8 at the beginning of the third horizontal line, and the pixel data P12 at the beginning of the fourth horizontal line. In the example of FIG. 3D, the pieces of pixel data P0, P4, P8, and P12 read from the register REGA and the pieces of pixel data P1, P5, P9, and P13 read from the register REGB are supplied to the processing unit 11, which executes a SIMD operation on the supplied data. The SIMD operation of this example involves parallel execution of the following four add operations, P0+P1, P4+P5, P8+P9, and P12+P13. That is, the SIMD operation of this example is filtering which involves adding up two pixels, for each column, in the horizontal direction of the image.

In step S5, results of the SIMD operation (P0=P0+P1, P4=P4+P5, P8=P8+P9, and P12=P12+P13), that is, the pieces of pixel data P0, P4, P8, and P12 obtained after filtering are stored in a register REG4 in the register file 12. Referring to FIG. 1, data read from the buffer 13 is supplied to the processing unit 11, which executes a SIMD operation on the supplied data. The results of the SIMD operation are stored in the register file 12, but are not written to the buffer 13.

In step S6, as in the case of step S4, in response to a vertical SIMD operation instruction, data in the registers REGB and REGC is read and subjected to a SIMD operation. In the example of FIG. 3E, the pieces of pixel data P1, P5, P9, and P13 read from the register REGB and the pieces of pixel data P2, P6, P10, and P14 read from the register REGC are supplied to the processing unit 11, which executes a SIMD operation on the supplied data. The SIMD operation involves parallel execution of the following four add operations, P1+P2, P5+P6, P9+P10, and P13+P14.

In step S7, results of the SIMD operation (P1=P1+P2, P5=P5+P6, P9=P9+P10, and P13=P13+P14), that is, the pieces of pixel data P1, P5, P9, and P13 obtained after filtering are stored in a register REG5 in the register file 12. Again, the results of the SIMD operation are not written to the buffer 13.

In step S8, as in the cases of steps S4 and S6, in response to a vertical SIMD operation instruction, data in the registers REGC and REGD is read and subjected to a SIMD operation. In the example of FIG. 3F, the pieces of pixel data P2, P6, P10, and P14 read from the register REGC and the pieces of pixel data P3, P7, P11, and P15 read from the register REGD are supplied to the processing unit 11, which executes a SIMD operation on the supplied data.

In step S9, results of the SIMD operation (P2=P2+P3, P6=P6+P7, P10=P10+P11, and P14=P14+P15), that is, the pieces of pixel data P2, P6, P10, and P14 obtained after filtering are stored in a register REG6 in the register file 12. Again, the results of the SIMD operation are not written to the buffer 13.

In step S10, the same processing as that of steps S1 to S9 is executed on the subsequent pieces of image data, and results of the SIMD operation are stored in a register REG7 in the register file 12. Thus, the results of the SIMD operation, that is, the pieces of pixel data P3, P7, P11, and P15 obtained after filtering are stored in the register REG7 in the register file 12.

In step S11, the SIMD operation results stored in the register REG4 in the register file 12 are transferred to the register REG0′ in the buffer 13. Specifically, the pieces of pixel data P0, P4, P8, and P12 obtained after filtering and stored in the register REG4 are stored in the register REG0′ in the buffer 13. FIG. 3G illustrates the buffer 13 in which the pieces of pixel data P0, P4, P8, and P12 obtained after filtering are stored in the register REG0′.

In step S12, as in the case of step S11, the SIMD operation results stored in the registers REG5 to REG7 in the register file 12 are transferred to the registers REG1′ to REG3′, respectively, in the buffer 13. FIG. 3H illustrates the buffer 13 in which the pieces of pixel data obtained after filtering are stored in the registers REG1′ to REG3′.

In step S13, image data in the register REGA in the buffer 13 is stored in the external memory 100. Specifically, as illustrated in FIG. 31, the pieces of image data P0, P1, P2, and P3 in the register REGA are read from the buffer 13 and written to the external memory 100 outside the processor 10.

In step S14, as in the case of step S13, image data in the registers REGB to REGD in the buffer 13 is stored in the external memory 100. Specifically, as illustrated in FIG. 31, the pieces of image data in the registers REGB to REGD are read from the buffer 13 and written to the external memory 100 outside the processor 10. Likewise, filtering is executed on the entire image in response to SIMD operation instructions.

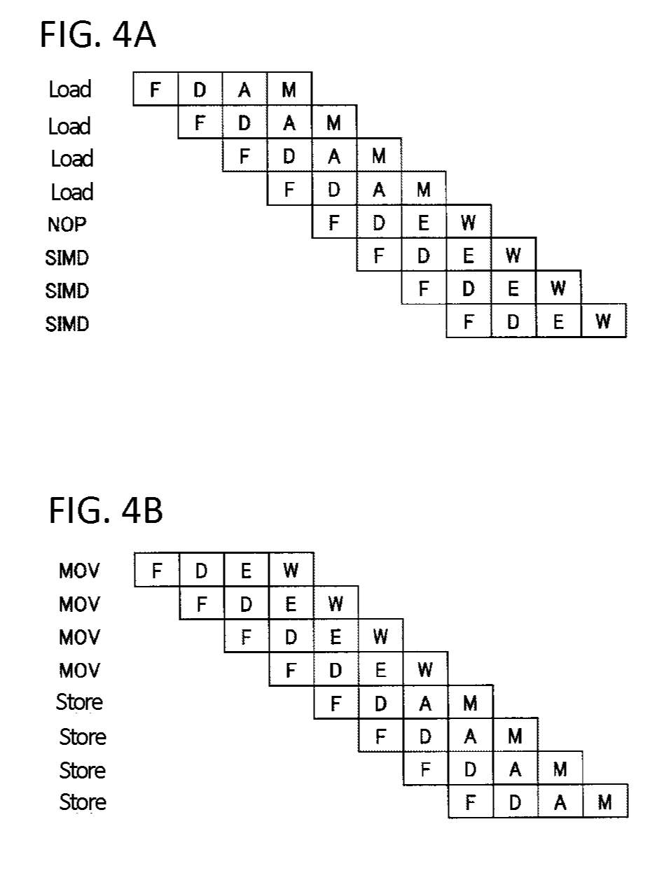

FIG. 4A and FIG. 4B illustrate pipeline operations in the data rearrangement and SIMD operations illustrated in FIG. 2. As illustrated in FIG. 4A, for execution of load instructions each having execution stages such as instruction fetch F, instruction decode D, load address generation A, and memory data load M, a pipeline operation is performed with a shift of one cycle between two consecutive load instructions. Thus, when a plurality of load instructions are sequentially executed, one load instruction may be seemingly executed in one cycle. Also, as illustrated in FIG. 4A, for execution of SIMD instructions each having execution stages such as instruction fetch F, instruction decode D, data read and operation E, and data write W, a pipeline operation is performed with a shift of one cycle between two consecutive SIMD instructions. Thus, when a plurality of SIMD instructions are sequentially executed, one SIMD instruction may be seemingly executed in one cycle.

As illustrated in FIG. 4B, for execution of move instructions (or transfer instructions) each having execution stages such as instruction fetch F, instruction decode D, register read E, and register write W, a pipeline operation is performed with a shift of one cycle between two consecutive move instructions. Also, as illustrated in FIG. 4B, for execution of store instructions each having execution stages such as instruction fetch F, instruction decode D, store address generation A, and memory data store M, a pipeline operation is performed with a shift of one cycle between two consecutive store instructions. Thus, each instruction may be seemingly executed in one cycle.

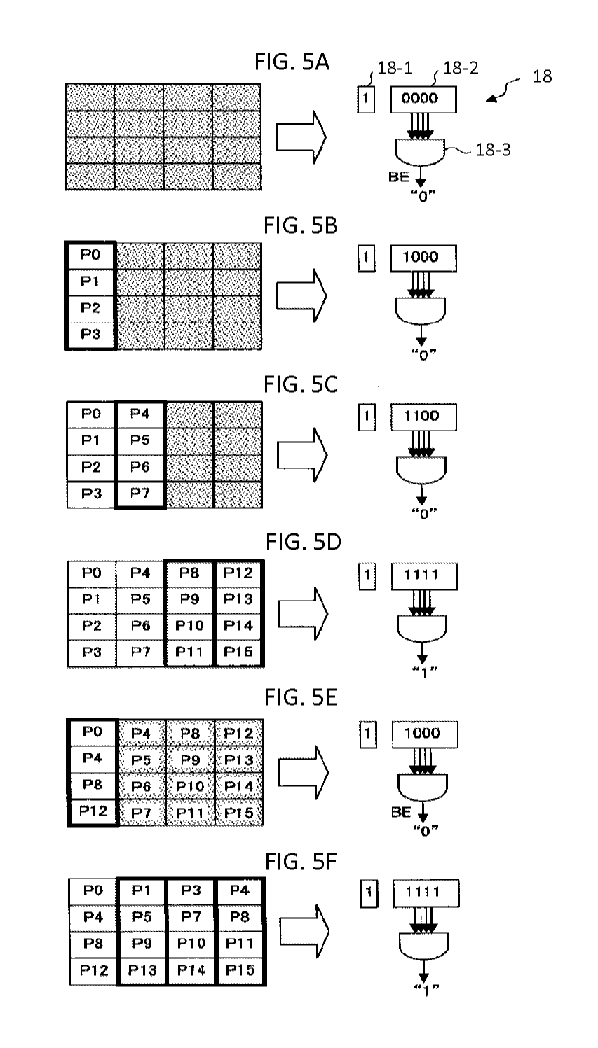

FIG. 5A to FIG. 5F are diagrams for explaining a series of operations of the buffer enable register 18. As illustrated in FIG. 5A, the buffer enable register 18 includes an enable flag 18-1, a register 18-2, and an AND circuit 18-3. The enable flag 18-1 is used to indicate whether to enable a control operation of the buffer enable register 18 for controlling the selectors 25 and 26. If the enable flag 18-1 is 0, the control operation of the buffer enable register 18 is not performed. If the enable flag 18-1 is 1, the control operation of the buffer enable register 18 is performed. The register 18-2 stores a 4-bit value that corresponds to four columns (i.e., the registers REG0′ to REG3′) in the buffer 13 and indicates whether a valid value is stored in each of the registers. If a bit value is 1, a valid value is stored in the corresponding register. If a bit value is 0, a valid value is not stored in the corresponding register. The AND circuit 18-3 performs an AND operation on the four bit values in the register 18-2 and outputs a result of the AND operation. If the output of the AND circuit 18-3 is 1, valid data is stored in the entire buffer 13. If the output of the AND circuit 18-3 is 0, there is an invalid part in the buffer 13. The selecting operation of the selectors 25 and 26 may be controlled depending on the output of the AND circuit 18-3.

FIG. 5A illustrates a state in which no data is stored in the buffer 13. In this state, four bit values in the register 18-2 are all 0. FIG. 5B illustrates a state in which after the enable flag 18-1 is set to 1, data is stored in the register REG0′ in the buffer 13. In this state, of the four bit values in the register 18-2, only a bit value corresponding to the register REG0′ is 1 and all the other bit values are 0. Therefore, the output of the AND circuit 18-3 is 0. FIG. 5C illustrates a state in which additional data is stored in the register REG1′ in the buffer 13 of FIG. 5B. In this state, the output of the AND circuit 18-3 is still 0. FIG. 5d illustrates a state in which additional data is stored in the registers REG2′ and REG3′ in the buffer 13 of FIG. 5C. In this state, the output of the AND circuit 18-3 becomes 1. That is, when valid values are stored in all the register elements 20 in the buffer 13 as illustrated in FIG. 5D, the output of the AND circuit 18-3 becomes 1, so that the selectors 25 and 26 may select the output of the buffer 13.

FIG. 5E illustrates a state in which, after the enable flag 18-1 in the state of FIG. 5D is temporarily set to 0 to reset the register 18-2 to zero, the enable flag 18-1 is set to 1 again and new data is stored in the register REG0′ in the buffer 13. The registers REG1′ to REG3′ are shaded to indicate that values stored therein are old invalid values. In this state, of the four bit values in the register 18-2, only a bit value corresponding to the register REG0′ is 1 and all the other bit values are 0. Therefore, the output of the AND circuit 18-3 is 0. FIG. 5F illustrates a state in which new data is stored in the registers REG1′ to REG3′ in the buffer 13 of FIG. 5E. In this state, the output of the AND circuit 18-3 becomes 1. That is, when new valid values are stored in all the register elements 20 in the buffer 13 as illustrated in FIG. 5F, the output of the AND circuit 18-3 becomes 1 again, so that the selectors 25 and 26 may select the output of the buffer 13.

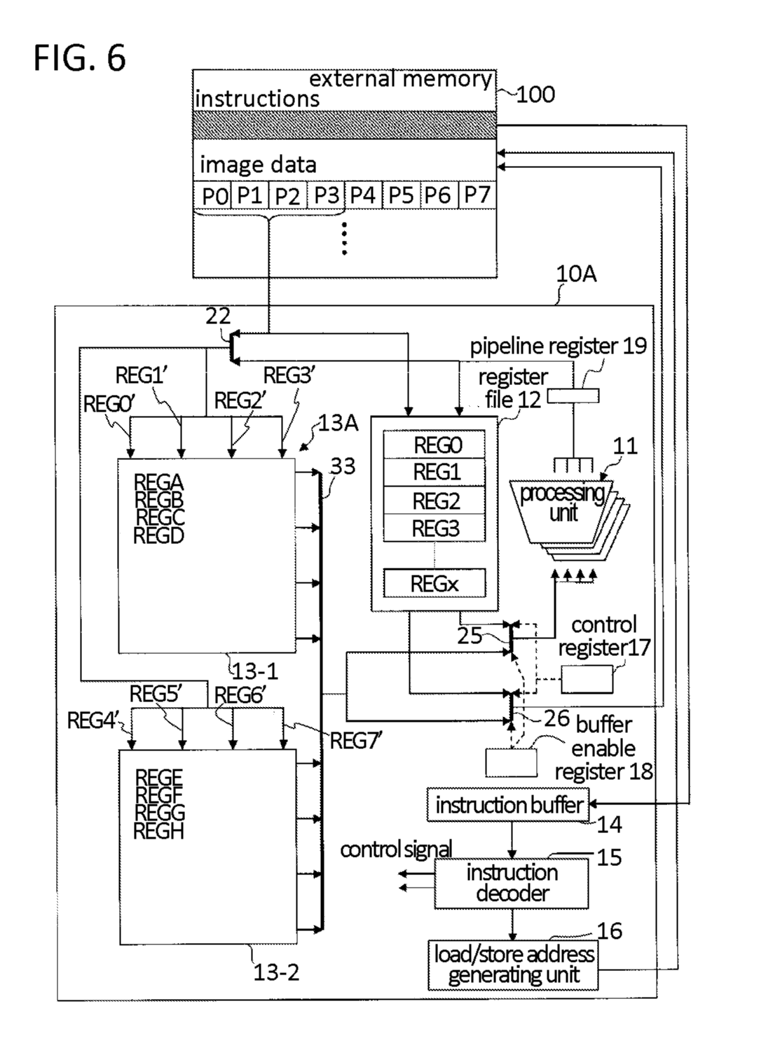

FIG. 6 illustrates a configuration of a modified processor. A processor 10A illustrated in FIG. 6 includes a buffer 13A, instead of the buffer 13. The buffer 13A includes a first buffer 13-1, a second buffer 13-2, the selector 22, and a selector 33. The selector 33 selects and outputs data from one of registers REGA to REGD in the first buffer 13-1 and registers REGE to REGH in the second buffer 13-2.

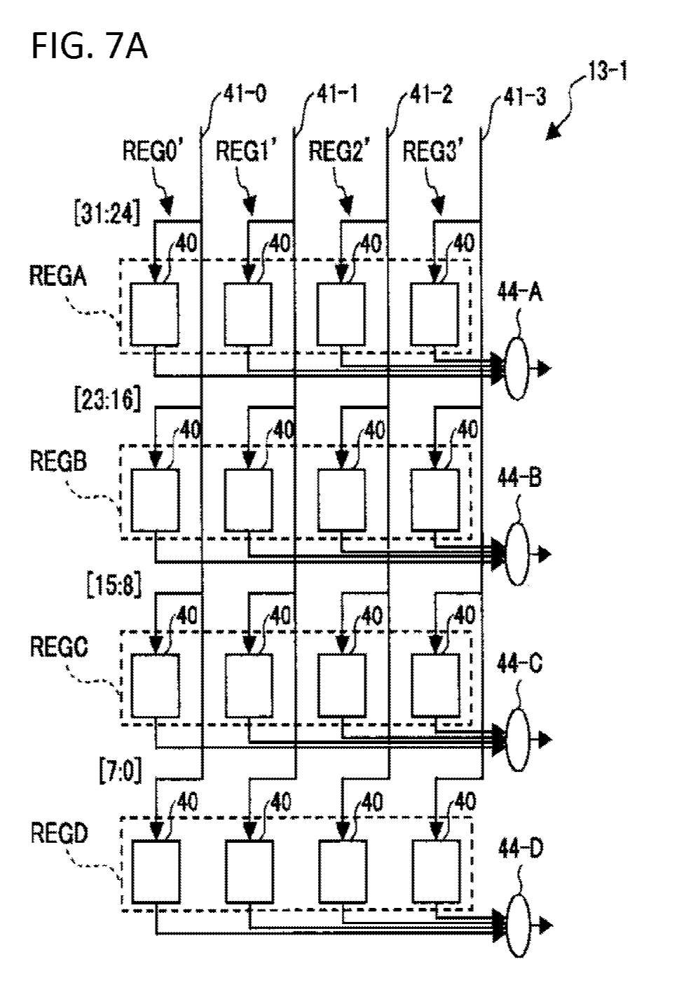

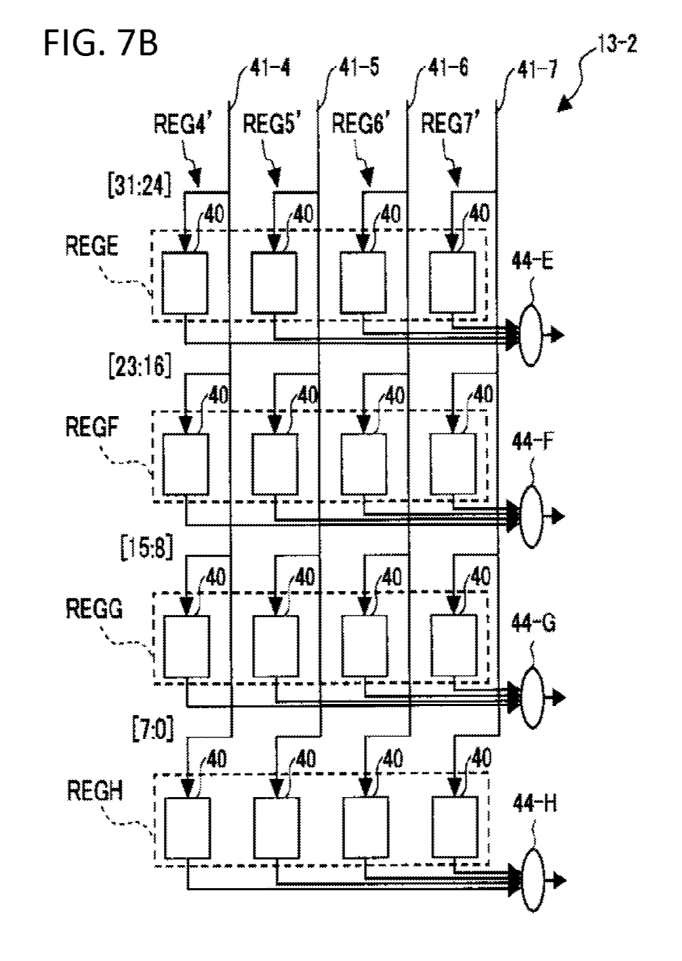

FIG. 7A and FIG. 7B illustrate configurations of the first buffer 13-1 and the second buffer 13-2, respectively. The first buffer 13-1 illustrated in FIG. 7A includes a plurality of register elements 40. Each of the plurality of register elements 40 may include, for example, eight flip-flops for storing an 8-bit data element. Four register elements 40 whose inputs are connected to a signal line 41-0 constitute one register REG0′. Four register elements 40 whose inputs are connected to a signal line 41-1 constitute one register REG1′. Four register elements 40 whose inputs are connected to a signal line 41-2 constitute one register REG2′. Four register elements 40 whose inputs are connected to a signal line 41-3 constitute one register REG3′.

The second buffer 13-2 illustrated in FIG. 7B includes a plurality of register elements 40. Four register elements 40 whose inputs are connected to a signal line 41-4 constitute one register REG4′. Four register elements 40 whose inputs are connected to a signal line 41-5 constitute one register REG5′. Four register elements 40 whose inputs are connected to a signal line 41-6 constitute one register REG6′. Four register elements 40 whose inputs are connected to a signal line 41-7 constitute one register REG7′.

Long-size (4-byte) image data is stored in one register designated from among the registers REG0′ to REG7′. A determination as to which register is to be used to store data may be controlled by a control signal from the instruction decoder 15.

In the first buffer 13-1 and the second buffer 13-2 illustrated in FIG. 7A and FIG. 7B, respectively, four register elements 40 whose outputs are connected to a signal-line coupling unit 44-X constitute one register REGX, where X is one of A to H. Each of the signal-line coupling units 44-A to 44-H arranges and combines 8-bit outputs from the respective register elements 40 to form 32-bit data, which is supplied to the selector 33 (see FIG. 6). The selector 33 selects and outputs one of the outputs of the registers REGA to REGH. A determination as to which register's data is to be selected is controlled by a control signal from the instruction decoder 15.

Thus, the first buffer 13-1 serves as a buffer where four data columns each having a plurality of data elements may be written on a column-by-column basis, and data elements at the same location may be selected and read as four data elements from the respective four data columns. The second buffer 13-2 also serves as a buffer where four data columns each having a plurality of data elements may be written on a column-by-column basis, and data elements at the same location may be selected and read as four data elements from the respective four data columns.

With the buffer 13A including the first buffer 13-1 and the second buffer 13-2 illustrated in FIG. 6, results of SIMD operations performed by the processing unit 11 may be directly stored in the buffer 13A and the results stored in the buffer 13A may be written to the external memory 100. In the configuration illustrated in FIG. 1, results of SIMD operations performed on data read from the buffer 13 are stored in the register file 12. This is because if the results are directly written to the buffer 13, other data stored in the buffer 13 and to be subjected to SIMD operations may be corrupted. Also, in the configuration illustrated in FIG. 1, SIMD operation results stored in the register file 12 are transferred to the buffer 13 and then the results stored in the buffer 13 are written to the external memory 100. This is because since rows and columns of a pixel array are switched as pre-processing for SIMD operations, it is preferable, before operation results are written to the external memory 100, to switch the rows and columns again to restore them to their original state as post-processing for the SIMD operations.

In contrast, in the configuration illustrated in FIG. 6, after data read from the external memory 100 is stored in the first buffer 13-1, the data read from the first buffer 13-1 is subjected to SIMD operations and results of the SIMD operations may be directly written to the second buffer 13-2. Then, the results read from the second buffer 13-2 may be written to the external memory 100. As described above, writing and reading to and from the first buffer 13-1 allows switching of rows and columns of a pixel array to be performed as pre-processing for SIMD operations, and writing and reading to and from the second buffer 13-2 allows switching of rows and columns of the pixel array to be performed as post-processing for the SIMD operations. Thus, image data having the pixel array restored to the original state may be stored in the external memory 100.

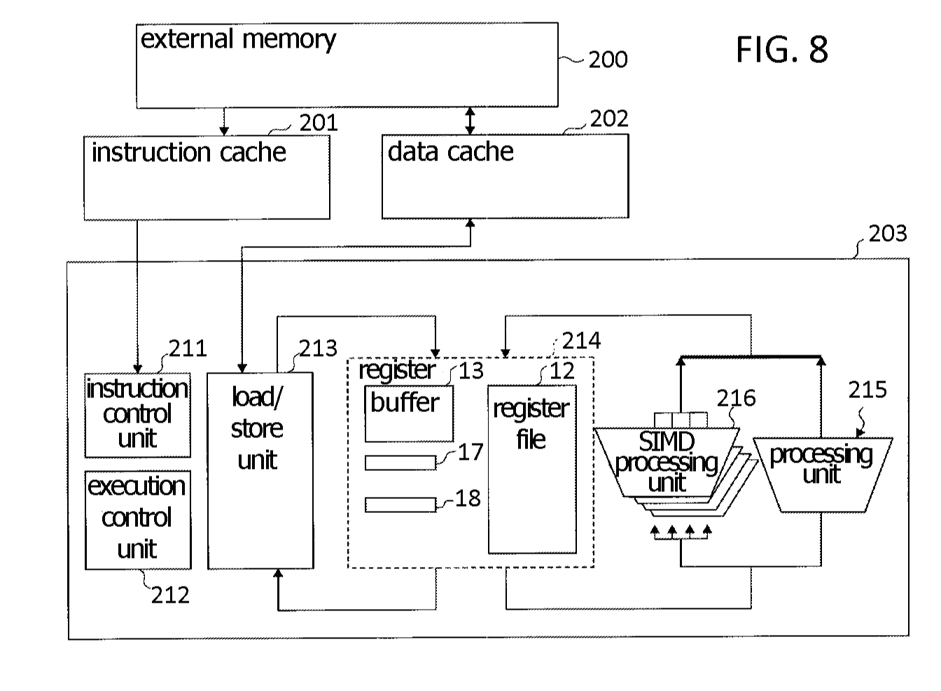

FIG. 8 illustrates a configuration of an information processing system including a media processor. The information processing system illustrated in FIG. 8 includes an external memory 200, an instruction cache 201, a data cache 202, and a media processor 203.

The media processor 203 includes an instruction fetch unit 211, an execution control unit 212, a load/store unit 213, a register unit 214, a processing unit 215, and a SIMD processing unit 216. The instruction fetch unit 211 fetches, from the instruction cache 201, an instruction stored at an address indicated by a program counter (not shown). If an instruction to be fetched is not stored in the instruction cache 201, the instruction fetch unit 211 loads the instruction from the external memory 200 into the instruction cache 201 and obtains the instruction from the instruction cache 201. The fetched instruction is decoded by the execution control unit 212. The execution control unit 212 includes a sequencer that controls an operation sequence of the media processor 203. The execution control unit 212 generates an appropriate control signal depending on the decoded instruction. An operation sequence of each unit of the media processor 203 is controlled by such a control signal. If the decoded instruction is, for example, a load instruction or a store instruction, the load/store unit 213 generates an address for loading or storing. If the decoded instruction is a load instruction, the load/store unit 213 reads, from the data cache 202, data stored at the address for loading. If data to be loaded is not stored in the data cache 202, the load/store unit 213 loads the data from the external memory 200 into the data cache 202 and obtains the data from the data cache 202. If the decoded instruction is a store instruction, the load/store unit 213 stores data in the data cache 202.

The register unit 214 includes the register file 12, the buffer 13, the control register 17, and the buffer enable register 18. These components have the same configurations and functions as those with the same reference numerals in FIG. 1.

On the basis of a control signal from the execution control unit 212, the processing unit 215 executes an operation corresponding to an instruction decoded by the execution control unit 212. On the basis of a control signal from the execution control unit 212, the SIMD processing unit 216 executes a SIMD operation corresponding to an instruction decoded by the execution control unit 212. In the SIMD operation, the SIMD processing unit 216 executes the same operation, in parallel, on multiple data elements supplied from the register file 12 or the buffer 13.

The present invention has been described on the basis of the embodiments. However, the present invention is not limited to these embodiments, and various modifications may be made within the scope of the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that the various changes, substitutions, and alterations could be made hereto without departing from the spirit and scope of the invention.

What is claimed is:

1. A processor comprising:
a processing unit capable of executing single-instruction multiple-data operations;
a register file configured to store data that is to be supplied to the processing unit and to be subjected to operations; and
a buffer provided separately from the register file, the buffer being a buffer where an integer “n” number of data columns each having a plurality of data elements are written on a column-by-column basis, and data elements at the same location are selected and read as “n” data elements from the respective “n” data columns,
wherein the “n” data elements read from the buffer is supplied to the processing unit as data to be subjected to a single-instruction multiple-data operation.

2. The processor according to claim 1, wherein the buffer has a data storage capacity smaller than or equal to that of the register file.

3. The processor according to claim 1, wherein the buffer is capable of storing the same number of data columns as the degree of parallelism of the single-instruction multiple-data operation.

4. The processor according to claim 1, wherein in response to a first operation instruction, data read from the register file is supplied to the processing unit as a target of the single-instruction multiple-data operation instruction, and in response to a second operation instruction different from the first operation instruction, the “n” data elements read from the buffer are supplied to the processing unit as a target of the single-instruction multiple-data operation instruction.

5. The processor according to claim 1, wherein in response to a first store instruction, data read from the register file is output externally, and in response to a second store instruction different from the first store instruction, data read from the buffer is output externally.

6. The processor according to claim 1, further comprising:
a control register in which a storage value is set in response to a register setting instruction; and
a selector circuit configured to select and output data read from the register file or data read from the buffer, depending on the storage value in the control register.

7. The processor according to claim 1, further comprising:
a buffer enable register configured to store a storage value indicating whether the buffer is enabled; and
a selector circuit configured to select and output data read from the register file or data read from the buffer, depending on the storage value in the buffer enable register.

8. An information processing system comprising:
a memory; and
a processor coupled to the memory,
wherein the processor includes
a processing unit capable of executing single-instruction multiple-data operations;
a register file configured to store data that is to be supplied to the processing unit and to be subjected to operations; and
a buffer provided separately from the register file, the buffer being a buffer where an integer “n” number of data columns each having a plurality of data elements are written on a column-by-column basis, and data elements at the same location are selected and read as “n” data elements from the respective “n” data columns,
wherein the “n” data elements read from the buffer is supplied to the processing unit as data to be subjected to a single-instruction multiple-data operation.

9. The information processing system according to claim 8, wherein the buffer has a data storage capacity smaller than or equal to that of the register file.

10. The information processing system according to claim 8, wherein the buffer is capable of storing the same number of data columns as the degree of parallelism of the single-instruction multiple-data operation.

11. The information processing system according to claim 8, wherein in response to a first operation instruction, data read from the register file is supplied to the processing unit as a target of the single-instruction multiple-data operation instruction, and in response to a second operation instruction different from the first operation instruction, the “n” data elements read from the buffer are supplied to the processing unit as a target of the single-instruction multiple-data operation instruction.

12. The information processing system according to claim 8, wherein in response to a first store instruction, data read from the register file is output externally, and in response to a second store instruction different from the first store instruction, data read from the buffer is output externally.

13. The information processing system according to claim 8, further comprising:
a control register in which a storage value is set in response to a register setting instruction; and
a selector circuit configured to select and output data read from the register file or data read from the buffer, depending on the storage value in the control register.

14. The information processing system according to claim 8, further comprising:
a buffer enable register configured to store a storage value indicating whether the buffer is enabled; and
a selector circuit configured to select and output data read from the register file or data read from the buffer, depending on the storage value in the buffer enable register.
